(19) United States
(12) Patent Application Publication
(10) Pub. No.: US 2009/0236541 A1
(43) Pub. Date: Sep. 24, 2009

(54) System and Methods for Optical Imaging

(75) Inventors: Stephen Johnson Lomnes, Philadelphia, PA (US); Michael Cooper, Cardiff (GB); Anup Sood, Clifton Park, NY (US); Siavash Yazdanfar, Niskayuna, NY (US); Kathleen Bove, Ballston Lake, NY (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: General Electric Company, Schenectady, NY (US)

(21) Appl. No.: 12/054,214

(22) Filed: Mar. 24, 2008

(51) Int. Cl. G01T 1/00

(52) U.S. Cl. 250/458.1; 250/362; 250/363.02

(57) ABSTRACT

The invention relates to imaging methods and systems. The systems may comprise a white light source configured to generate light in a first wavelength range, an excitation source configured to generate light at one or more wavelengths for exciting a fluorescent substance, a first detector configured to acquire reflectance image data that represents white light reflected from a subject, and a second detector configured to acquire fluorescence image data that represents fluorescence emissions from the subject. At least one of the one or more wavelengths generated by the excitation light source is within the first wavelength range of the white light source. The fluorescent substance may be, for example, a fluorescent dye that is injected into a patient before or during a surgery. The system may also include an image processing engine and a display. The image processing engine may receive the reflectance image data and the fluorescence image data and generate a merged image in which the fluorescence image data is superimposed on the reflectance image data. The display may be used by a surgeon, for example, to more effectively visualize the surgical site during surgery.

### FIELD OF THE INVENTION

The subject matter disclosed herein relates generally to optical imaging, and more particularly to systems and methods for in vivo optical imaging using fluorescent reporters.

### BACKGROUND

Fluorescence imaging is a technique that has been used in various applications in biological sciences. For example, fluorescence imaging has been applied in fields such as biomedical diagnostics, fluorescence guided surgery, and genetic sequencing. Typically, fluorescence imaging systems and methods involve injection of a fluorescent substance into a subject to be imaged and application of an excitation light source to illuminate the subject. The subject fluoresces either exogenously or endogenously in response to the excitation, and the resulting fluorescence emission is imaged to obtain information about the interior composition of the subject.

Various systems are known for generating images consisting of a fluorescent image superimposed on a visible light image. For example, U.S. Patent Application Publication No. 2005/0182321 discloses a medical imaging system that provides simultaneous rendering of visible light and fluorescent images. The system employs dyes that remain in a subject's blood stream for several minutes, allowing real-time imaging of the subject's circulatory system superimposed upon a visible light image of the subject. The system provides an excitation light source to excite the fluorescent substance and a visible light source for general illumination. The system may be used in imaging applications where a visible light image is supplemented by an image formed from fluorescent emissions from a fluorescent substance that marks areas of functional interest.

Prior imaging systems, however, suffer from a number of drawbacks. For example, in many applications, the quality of the resulting image depends significantly on the configuration and performance of the visible light source and the excitation light source and on the fluorescent dye that is used. In some systems, a white light filter is used that is spectrally distinct from the excitation filter, which limits the amount of light that is useful in stimulating fluorescence. Consequently, the resulting fluorescent emission is compromised. In addition, improvements in the visible light source are also desirable for enhanced image quality. Depending upon the particular wavelength needed, light sources may take a number of forms, from conventional light bulbs, to laser light sources, X-ray light sources, and so forth. Within the visible spectrum, light source power density is often limited by the physics of the light source. For high intensity applications, however, new techniques are desirable for improved light sources that can provide higher energy densities at a specified distance from the light source.

### SUMMARY

According to one embodiment, the invention relates to an imaging system comprising a white light source configured to generate light in a first wavelength range, an excitation source configured to generate light at one or more wavelengths for exciting a fluorescent substance, a first detector configured to acquire reflectance image data that represents light reflected from a subject, and a second detector configured to acquire fluorescence image data that represents fluorescence emissions from the subject, wherein at least one of the one or more wavelengths generated by the excitation source is within the first wavelength range of the white light source. The fluorescent substance may be, for example, a fluorescent dye that is injected into a patient before, at the beginning of, or during a surgery.

Exemplary embodiments of the system may also include an image processing engine and a display. The image processing engine may receive the reflectance image data and the fluorescence image data and generate a merged image in which the fluorescence image data is superimposed on the reflectance image data. The display may be used by a surgeon, for example, to more effectively visualize the surgical site during surgery. Exemplary embodiments of the invention may also provide the advantage of improved excitation of the fluorescent substance. For example, the fluorescent substance may have improved excitation because it is excited by both the excitation light source and a portion of the spectrum emitted by the white light source.

According to another embodiment, the invention relates to a method comprising illuminating a subject with a white light source configured to generate light in a first wavelength range, illuminating the subject with an excitation source configured to generate light at one or more wavelengths for exciting a fluorescent substance, acquiring reflectance image data that represents light reflected from a subject, and acquiring fluorescence image data that represents fluorescence emissions from the subject, wherein at least one of the one or more wavelengths generated by the excitation source is within the first wavelength range of the white light source.

The invention also relates to imaging agents used with the imaging system. In one embodiment, the imaging agents used comprise fluorescent dyes, pigments, nanoparticles, or combinations thereof, either by themselves or as conjugates of carriers that are targeted or non-targeted. The fluorescent agents may be injected systematically, applied directly to the region of interest, or produced endogenously at the target site. In a preferred embodiment, the imaging agents are fluorescent dyes that absorb light having, e.g., a wavelength greater than 600 nanometers (nm), and emit light having a wavelength in the range of, e.g., from about 600 nm to about 1000 nm. For surgical applications, e.g., during surgical interventions, agents with excitation and emissions in the wavelength range 400-600 nm may also be used. Agents with a Stokes shift greater than 10 nm are are typically used, but other agents with a smaller Stokes shift may also be used.

In one embodiment, the imaging agents used comprise fluorescent dyes, pigments, nanoparticles, or combinations thereof, either by themselves or as conjugates of carriers that are targeted or non-targeted. Exemplary imaging agents include indocyanine green, as well as:

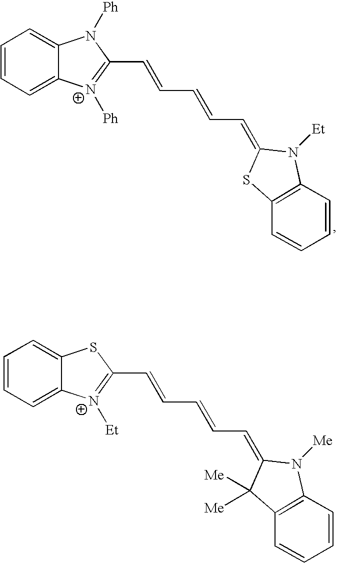

IRDye78, IRDye80, IRDye38, IRDye40, IRDye41, IRDye700, IRDye800 (Li-Cor Biosciences, Lincoln, Nebr.), IRDye78, IRDye78-CA, and compounds formed by conjugating a second molecule to any such dye, e.g., a protein or nucleic acid conjugated to IRDye800, IRDye40, or Cy7, etc.

Still other dyes contemplated by the present invention include phenothiazines such as methylene blue and cyanines such as Cy5 and Cy5.5 (GE Healthcare). Additional dyes include Dy630-Dy636, Dy647-Dy649, Dy650-652, Dy675-Dy677, Dy680-682, Dy700, Dy701, Dy730-Dy732, Dy734, Dy750-Dy752, Dy776, Dy780-Dy782, Dy831 or mixtures or conjugates thereof, and Atto633, Atto635, Atto637, Atto647, Atto655, Atto680, Atto700, Atto725, Atto740 or mixtures or conjugates thereof.

According to other embodiments, the invention relates to a medical imaging system that provides simultaneous display of visible light and fluorescence images. In one embodiment, the system provides an excitation light source to excite the fluorescent substance and a visible light source for general illumination within the same optical guide that is used to capture images. The excitation light source may transmit light of one or more wavelengths that are within the wavelength range of a white light source. In another embodiment, the system is configured for use in open surgical procedures. The systems described herein may be used in imaging applications where a visible light image may be supplemented by an image formed from fluorescent emissions from a fluorescent substance that marks areas of functional interest.

In another embodiment, the system may include a visible light source illuminating a subject, the visible light source providing a range of wavelengths including one or more wavelengths of visible light, an excitation light source illuminating the subject, the excitation light source providing at least one excitation wavelength within the range of wavelengths of the visible light source, a fluorescent substance introduced into a circulatory system of the subject, the fluorescent substance being soluble in blood carried by the circulatory system and the fluorescent substance emitting photons at an emission wavelength in response to the excitation wavelength, an electronic imaging device that captures an image of a field of view that includes some portion of the subject and the circulatory system of the subject, the image including a first image obtained from the one or more wavelengths of visible light and a second image obtained from the emission wavelength, and a display that displays the first image and the second image, the second image being displayed at a visible light wavelength.

The electronic imaging device may include a video camera sensitive to visible light. The electronic imaging device may include one or more emission wavelength cameras. The electronic imaging device may capture a visible light image and an emission wavelength image, the system further including a processor that converts the emission wavelength image to a converted image having one or more visible light components, and combines the converted image with the visible light image for display. The electronic imaging device may capture a visible light image and an emission wavelength image, the system further including a processor that converts the emission wavelength image to a converted image having one or more visible light components, and superimposes the converted image onto the visible light image for display.

The system may include a display that displays images captured by the electronic imaging device. The display may be provided to a physician for use during a procedure, the procedure being a surgical procedure, a diagnostic procedure, or a therapeutic procedure, for example.

An exemplary method as described herein may include illuminating a subject with a range of wavelengths of white light, concurrently illuminating the subject with at least one excitation wavelength that is within the wavelength range of white light, introducing a fluorescent substance into the subject, the fluorescent substance being soluble in blood carried by the circulatory system and the fluorescent substance emitting photons at an emission wavelength in response to the excitation wavelength, electronically capturing a visible light image of the subject, electronically capturing an emission wavelength image of the subject that shows the circulatory system, and displaying concurrently the visible light image of the subject and the emission wavelength image of the circulatory system.

Exemplary embodiments of the present invention also provide improved light sources. The light sources may be used in a wide range of applications, particularly where high energy intensities are desired in relatively narrow or reduced areas. The light sources can be modular, scalable and configurable incoherent light sources, according to exemplary embodiments of the invention.

The invention also relates to an article of manufacture which comprises a computer usable medium having computer readable program code means embodied therein for causing a computer to execute the imaging methods described herein.

### BRIEF DESCRIPTION OF THE DRAWINGS

These and other features and aspects of exemplary embodiments of the invention will become better understood when reading the following detailed description with reference to the accompanying drawings, in which like characters represent like parts throughout the drawings, and wherein:

FIG. 1 is a block diagram of an imaging system according to one embodiment of the present invention;

FIG. 2 is a block diagram of an imaging system including an endoscope with proximal detectors according to another embodiment of the invention;

FIG. 3 is a block diagram of an imaging system including an endoscope with distal detectors according to another embodiment of the invention;

FIG. 4 is a diagram of an endoscope in which the white light source shares an optical path with the reflected light and the fluorescence emission according to an exemplary embodiment of the invention;

FIG. 5 is a diagram of an endoscope in which the excitation source shares an optical path with the reflected light and the fluorescence emission according to an exemplary embodiment of the invention;

FIG. 6 is a diagram showing the wavelength ranges for a white light source, an excitation source, and a fluorescence emission band according to an exemplary embodiment of the invention;

FIG. 7 is a diagram showing the relationship between the wavelength ranges for a white light source, an excitation source, and a fluorescence emission band according to a prior art system;

FIG. 8 is a table showing exemplary wavelength ranges for a white light filter, an excitation filter, and an emission filter for examples of fluorescent dyes;

FIG. 9 is a graph depicting the approximate absorption and emission bands of Alexa 430;

FIG. 10 is a diagram of an imaging system comprising multiple detectors and multiple excitation sources according to an exemplary embodiment of the invention;

FIG. 11 is a drawing of a light source and supporting circuitry in accordance with another embodiment of the present invention;

FIG. 12 is a pictorial representation of how the arrangement of FIG. 11 focuses light from modules in an array towards an illuminated region;

FIG. 13 is a perspective view of an imaging unit incorporating a light source in accordance with an exemplary embodiment of the invention; and

FIG. 14 depicts an exemplary medical imaging application utilizing the imaging unit of FIG. 13.

While the drawings illustrate system components in a designated physical relation to one another or having electrical communication designation with one another, and process steps in a particular sequence, such drawings illustrate examples of the invention and may vary while remaining within the scope of the invention as contemplated by the inventors. For example, components illustrated within the same housing may be located within the same housing, merely in electrical communication with one another, or otherwise. Additionally, illustrated data flows are merely exemplary and any communication channel may be utilized to receive and transmit data in accordance with exemplary embodiments of the invention.

### DETAILED DESCRIPTION

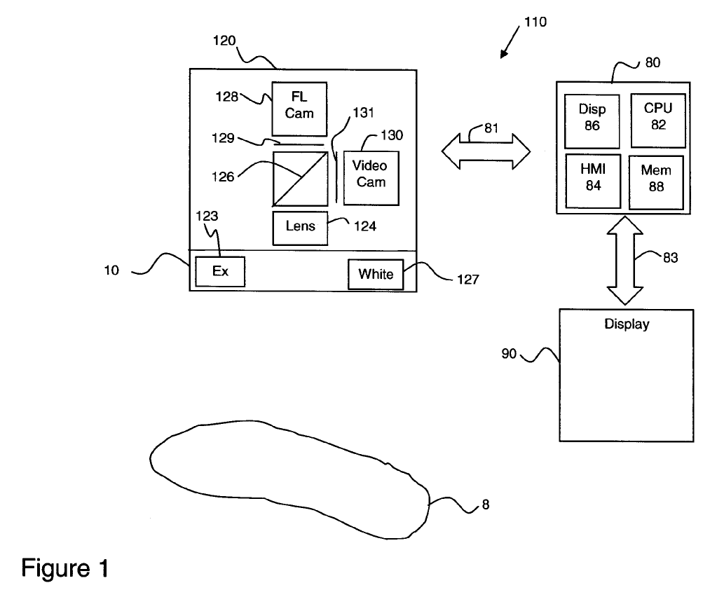

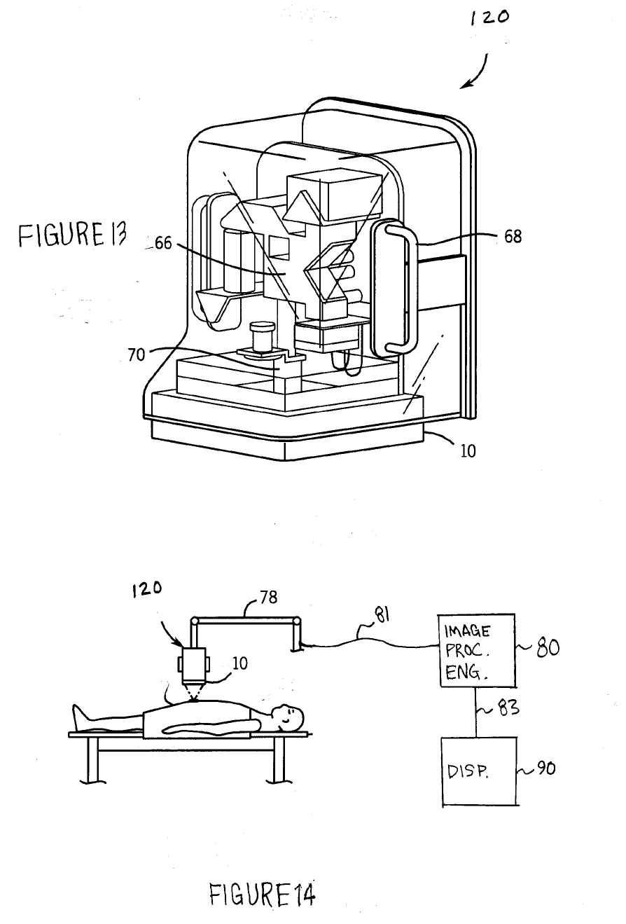

FIG. 1 is a diagram of an imaging system according to one embodiment of the present invention. As shown in FIG. 1, the imaging system 110 includes an imaging unit 120, an image processing engine 80, and a display 90. The imaging unit 120 includes a light source 10 to illuminate the subject 8 and to excite a fluorescent substance in the subject. The imaging unit 120 also includes detectors and other components that detect a fluorescence emission and reflected light from the subject 8 and send image signals to the image processing engine 80 via a communications channel 81. The image processing engine 80 includes a computer or other processing device to process the image signals received from the imaging unit 120. The imaging system 110 also includes a display 90, connected to the image processing engine 80 via a communications channel 83, that may be used by the surgeon for displaying an image of the subject 8 during surgery, such as a fluorescence image combined with a reflectance image of the subject 8. During surgery, the surgeon positions the imaging unit 120 to illuminate the subject 8 and to acquire fluorescence and reflectance images of the subject 8, as shown in FIG. 14. The image processing engine 80 may be configured to process the image signals acquired by the imaging unit 120 and to display for the surgeon on the display 90 a merged reflectance/fluorescence image to assist the surgeon in visualizing the area to be treated during surgery.

Referring again to FIG. 1, the imaging unit 120 includes a lens 124, a beam splitter 126, a fluorescence camera 128 and a video camera 130 according to an exemplary embodiment of the invention. The fluorescence camera 128 and the video camera 130 may be referred to as “detectors” and may be digital or analog, for example. The imaging unit 120 includes a light source 10 which includes an excitation source 123 and a white light source 127. The excitation source 123 transmits light of one or more wavelengths to the subject 8. The one or more wavelengths are selected to excite the fluorescent substance in the subject 8, which may be injected into the subject prior to or during the surgery or may be an endogenous fluorescent substance. The excitation light source 123 may be any light source that emits an excitation light capable of causing a fluorescence emission from the fluorescent substance. This may include, for example, light sources that use light emitting diodes, laser diodes, lamps, and the like. The excitation source 123 and the white light source 127 may each comprise a multitude of light sources and combination of light sources, such as arrays of light emitting diodes (LEDs), lasers, laser diodes, lamps of various kinds, or other known light sources. The white light source 127 may comprise an incandescent, halogen, or fluorescence light source, for example. Either or both of the white light source 127 and the excitation source 123 may include filters (not shown in FIG. 1) to filter out any wavelengths that overlap with the wavelength band of the fluorescence emission from the subject 8.

As used herein, the term “reflectance image data” refers to image information indicative of a reflection of light from a surface. As used herein, the term “fluorescence image data” refers to image information indicative of a fluorescent emission from a subject.

The fluorescence emission and the visible light reflected from the subject 8 are received through the lens 124 and then propagate to a beam splitter 126. The lens 124 is configured to focus an image onto the fluorescence camera 128 and the video camera 130. The lens 124 may be any lens suitable for receiving light from the surgical field and focusing the light for image capture by the fluorescence camera 128 and the video camera 130. The lens 124 may be designed for manual or automatic control of zoom and focus. The beam splitter 126 splits the image information into different paths either spectrally, for example with the use of dichroic filters, or by splitting the image with a partially reflective surface. The beam splitter 126 divides the fluorescence emission from the remainder of the light. The fluorescence emission travels through a filter 129 and then to the fluorescence camera 128. The filter 129 is configured to reject the reflected visible and excitation light from being detected by the fluorescence camera 128 while allowing the emitted fluorescent light from the subject 8 to be detected by the fluorescence camera 128. The fluorescence camera 128 may be any device configured to acquire fluorescence image data, such as a charge coupled device (CCD) camera, a photo detector, a complementary metal-oxide semiconductor (CMOS) camera, and the like. The fluorescence camera 128 may be analog or digital. The fluorescence camera 128 receives the filtered fluorescence emission and converts it to a signal that is transmitted to the image processing engine 80 via communications channel 8T. The remainder of the light passes through a filter 131 and then to a video camera 130. The filter 131 preferably ensures that the excitation light and fluorescence emission is rejected from detection to allow for accurate representation of the visible reflected light image. The video camera 130 may be any device configured to acquire reflectance image data, such as a charge coupled device (CCD) camera, a photo detector, a complementary metal-oxide semiconductor (CMOS) camera, and the like. The video camera 130 receives the filtered reflected light and converts it to a signal or image data that is transmitted to the image processing engine 80 via communications channel 81. The video camera 130 may be analog or digital.

The image processing engine 80 includes a human machine interface (HMI) 84, such as a keyboard, foot pedal or other interface mechanism, which allows the surgeon or an assistant to control the imaging system 110. The image processing engine 80 may also include a display 86 which may be used primarily for displaying control information related to the image processing engine 80.

The image processing engine 80 receives video signals from the imaging unit 120 and processes the signals. The image processing engine 80 includes a processor 82 that executes various image processing routines as described further herein. The image processing engine 80 also includes a memory 88 for storing, among other things, image data and various computer programs for image processing. The memory 88 may be provided in various forms, such as RAM, ROM, hard drive, flash drive, etc. The memory 88 may comprise different components for different functions, such as a first component for storing computer programs, a second component for storing image data, etc. The image processing engine 80 may include hardware, software or a combination of hardware and software. The image processing engine 80 is programmed to execute the various image processing methods described herein. Prior to surgery, the surgeon or an assistant may enter various parameters through the HMI 84 to define and control the imaging method that will occur during surgery. The surgeon or an assistant may also modify the imaging method during surgery or input various commands during surgery to refine the images being displayed. The display 86 may be used for controlling the imaging system 10, and it may also be used to display images of the subject 8.

The display 90 is typically used to display images of the subject 8 for the surgeon. The display 90 may comprise a larger screen that is positioned closer to the surgeon so that the surgeon can view the images easily during surgery. The display 90 may comprise a plasma screen, an LCD display, an HDTV, or other know high resolution display device. The display 90 may also include controls allowing the surgeon to adjust brightness, contrast and/or gain of the image, for example.

The displays 90 and 86 may present the same data or they may present different data, such as images on display 90 and imaging parameters on display 86. Those skilled in the art will appreciate that various configurations of displays, input devices, processors, and memory, can be utilized to process and display images for the surgeon according to various embodiments of the invention. For example, in some embodiments, the hardware may include one or more digital signal processing (DSP) microprocessors, application-specific integrated chips (ASIC), field programmable gate arrays (FPGA), or the like. In some embodiments, the software may include modules, submodules and generally computer program products containing computer code that may be executed to perform the image processing methods of the embodiments of the invention. The memory 88 may be any type of memory suitable for storing information that may be accessed by the processor 82 for performing image processing. Information stored may include one or more previously acquired image data sets, computer programmable code for executing image processing or any other information accessed by processor 82. The memory 88 may include, but is not limited to, random access memory (RAM), read-only memory (ROM), flash memory and/or a hard disk drive. In various embodiments, memory 88 may store computer executable code that may be executed on processor 82. The memory 88 may also include information descriptive of the subject 8 on which the surgery is being performed.

The image processing engine 80 typically provides digital filtering, gain adjustment, color balancing, and may include any other conventional image processing functions. The image processing engine 80 may also be programmed to shift the image data from the fluorescence camera 128 into the visible light range for display at some prominent wavelength, such as a color distinct from the visible light colors of the surgical field, so that a superimposed image will clearly depict the dye.

According to other embodiments of the invention, the imaging system includes an endoscope. The endoscope may be used in endoscopic surgery, which can be significantly less invasive as compared with open surgery. The endoscope is inserted into a cavity in the patient, as known in the art, to minimize the invasive nature of the surgery. Endoscopes are commercially available from a number of manufacturers, such as Stryker and Karl Storz, for example.

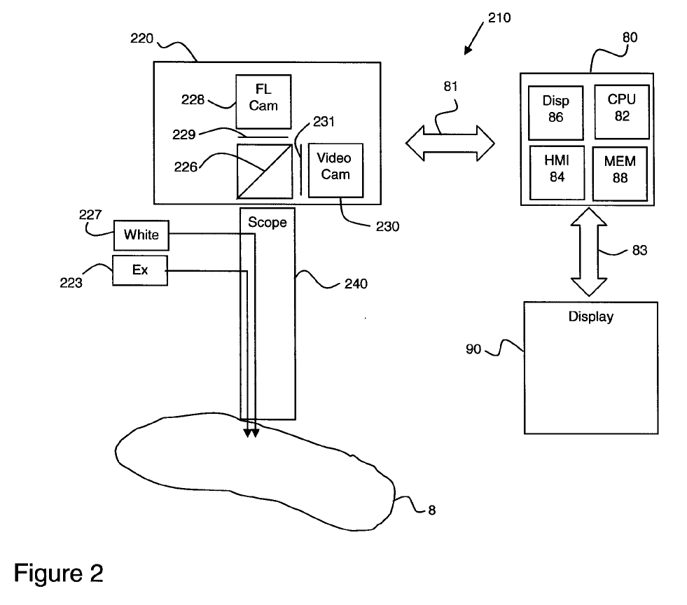

According to exemplary embodiments of the invention, the endoscope may include proximal detectors or distal detectors. FIG. 2 is a diagram of an endoscope system having proximal fluorescence detectors. The detectors are referred to as proximal detectors, because they are located near the top end of the endoscope 240 proximate to the surgeon. As shown in FIG. 2, the imaging system 210 comprises an imaging unit 220 that houses a beam splitter 226, a fluorescence camera 228, a filter 229, a video camera 230 and a filter 231. The imaging system 210 also includes an excitation source 223 and a white light source 227. The excitation source 223 and the white light source 227 are optically coupled to the endoscope 240 at or near the proximal end of the endoscope 240. The functions of the beam splitter 226, the cameras 228, 230, the filters 229, 231, the excitation source 223 and the white light source 227 are substantially the same as the corresponding elements in FIG. 1.

The endoscope is connected via communications channel 81 to the image processing engine 80 which includes a processor 82, human machine interface (HMI) 84 such as a keyboard, foot pedal, or control buttons, output device 86 such as a display, and one or more memories 88 as described previously. The image processing engine 80 is connected to the display 90 via communications channel 83. The image processing engine 80 and the display 90 operate in essentially the same manner as described above with respect to FIG. 1.

In practice, a fluorescent agent is injected into or applied to the subject and the endoscope 240 is inserted into a body cavity or incision. The white light source 227 and the excitation source 223 are activated, image data are acquired, and the image data are processed. The endoscope 240 can provide the advantages associated with minimally invasive surgery, for example.

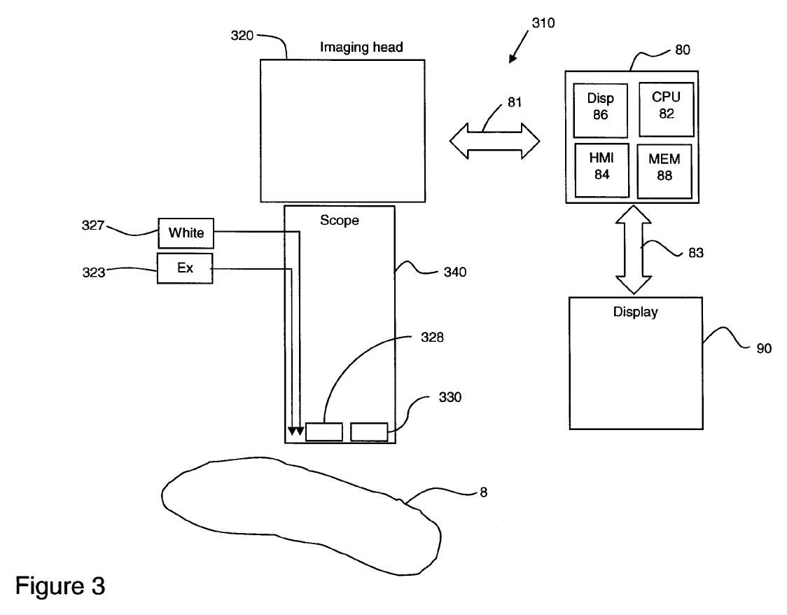

A second embodiment of an endoscope is shown in FIG. 3. The endoscope depicted in FIG. 3 includes distal detectors 328, 330. The fluorescence detector 328 and the video camera 330 are referred to as distal detectors because they are located at the bottom end of the endoscope away from the surgeon. The imaging system 310 also includes an excitation source 323 and a white light source 327. The excitation source 323 and the white light source 327 are optically coupled to the endoscope 340 at or near the proximal end of the endoscope 340. The functions of the detectors 328, 330, the excitation source 323 and the white light source 327 are substantially the same as the corresponding elements in FIG. 1. The imaging system 310 also comprises an imaging unit 320 that relays the signals and data acquired by the endoscope 340 to the imaging processing engine 80.

The imaging unit 320 is connected via communications channel 81 to the image processing engine 80 which includes a processor 82, HMI 84, output device 86 such as a display, and one or more memories 88 as described previously. The image processing engine 80 is connected to the display 90 via communications channel 83. The image processing engine and the display 90 operate in essentially the same manner as described above with respect to FIG. 1.

In practice, a fluorescent agent is injected into or otherwise applied to the subject and the endoscope 340 is inserted into a body cavity. The white light source 327 and the excitation source 323 are activated, image data are acquired, and the image data are processed.

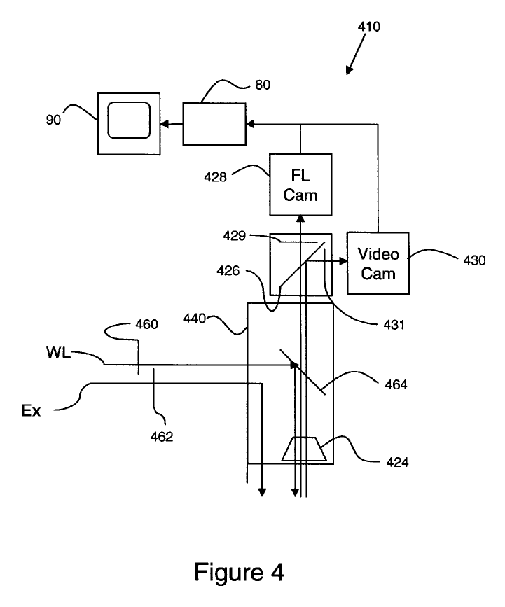

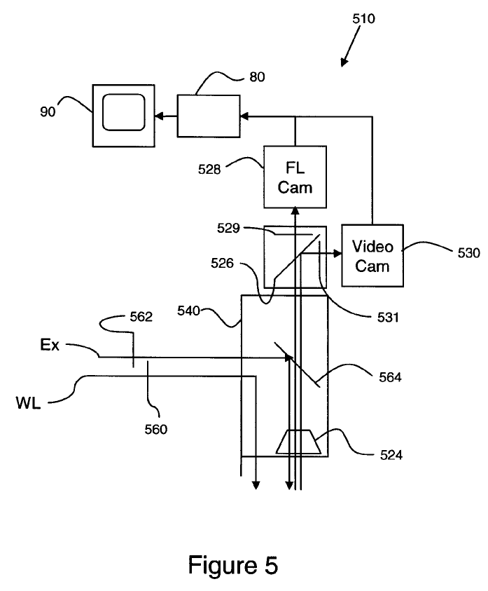

According to other embodiments of the invention, the endoscope, or other medical device or scope, can be configured such that the white light source and/or the excitation source shares an optical path with the reflected light and the fluorescent emission. These embodiments are shown in FIGS. 4 and 5. In FIG. 4, the imaging system 410 includes a fluorescence camera 428, a video camera 430, an image processing engine 80, a display 90, filters 429, 431, and a beam splitter 426 as previously described. The white light from the white light source 427 may be coupled through a white light filter 460 into the endoscope 440 where it joins the same optical path as the reflected light and the fluorescence emission from the subject. Generally, the white light provided by the white light source 427 does not include a wavelength range that overlaps the wavelength range of the fluorescent emission. The white light filter 460 may or may not be used depending on the wavelength range of the white light source 427. If the white light filter 460 is included, it is typically configured to remove any wavelength range from the white light source 427 that overlaps or interferes with the wavelength range of the fluorescent emission. The white light filter 460 may comprise a band pass or short pass filter, for example. The beam splitter 464 may comprise a partially reflective mirror that is configured to reflect a portion of the light incident upon it and transmit the remainder of the light incident upon it. The white light, fluorescent emission and reflected light may travel in free space between the beam splitter 464 and the lens 424, for example. The excitation light from the excitation source 423 may be coupled through an excitation filter 462 into the endoscope 440 where it travels in a different optical path from the white light, reflected light and fluorescence emission. The excitation light may travel through an optical fiber or other waveguide, for example. The excitation light is configured to have a wavelength range that excites the fluorescent substance in the subject. Generally, the excitation light provided by the excitation source 423 does not include a wavelength range that overlaps the wavelength range of the fluorescent emission. The excitation filter 462 may or may not be used depending on the wavelength range of the excitation source 423. If the excitation filter 462 is included, it is typically configured to remove any wavelength range from the excitation source 423 that overlaps or interferes with the wavelength range of the fluorescent emission. The excitation filter 462 may comprise a band pass or short pass filter, for example.

In FIG. 5, the imaging system 510 includes a fluorescence camera 528, a video camera 530, an image processing engine 80, a display 90, filters 529, 531, and a beam splitter 526 as previously described. The excitation light from the excitation source 523 may be coupled through an excitation filter 562 into the endoscope 540 where it joins the same optical path as the reflected light and the fluorescence emission from the subject. Generally, the excitation light provided by the excitation source 523 does not include a wavelength range that overlaps the wavelength range of the fluorescent emission. The excitation filter 562 may or may not be used depending on the wavelength range of the excitation source 523. If the excitation filter 562 is included, it is typically configured to remove any wavelength range from the excitation source 523 that overlaps or interferes with the wavelength range of the fluorescent emission. The excitation filter 562 may comprise a band pass or short pass filter, for example. The beam splitter 564 may be a dichroic filter, for example, that reflects a narrow wavelength band of light, e.g., the band produced by the excitation source 523, and transmits other wavelengths, as in a notch filter. The excitation light, fluorescent emission, and reflected light may travel in free space between the beam splitter 564 and the lens 524, for example. The white light from the white light source 527 may be coupled through a white light filter 560 into the endoscope 540 where it travels in a different optical path from the excitation light, reflected light and fluorescence emission. The white light may travel through an optical fiber or other waveguide, for example. Generally, the white light provided by the white light source 527 does not include a wavelength range that overlaps the wavelength range of the fluorescent emission. The white light filter 560 may or may not be used depending on the wavelength range of the white light source 527. If the white light filter 560 is included, it is typically configured to remove any wavelength range from the white light source 527 that overlaps or interferes with the wavelength range of the fluorescent emission. The white light filter 560 may comprise a band pass or short pass filter, for example.

As will be appreciated by those skilled in the art, the imaging systems described herein can be modified to include a laparoscope, colonoscope or other known surgical scopes or devices. A laparoscope is typically inserted into an incision in the abdomen to provide access to an interior of the abdomen in a minimally invasive procedure. A colonoscope is inserted into the colon. The various devices and scopes can be rigid or flexible and the detectors can be proximal, distal, analog or digital, for example. The imaging systems can be used for surgical applications, diagnostic applications, and therapeutic applications.

The imaging systems are configured to execute various imaging methods. According to exemplary embodiments of the invention, the imaging methods include injecting or otherwise applying a fluorescent substance to a subject. The fluorescent substance may comprise, for example, a fluorescent dye, pigment or nanoparticle, either by itself or as conjugates of carriers that are targeted or non-targeted. Examples of preferred imaging agents include those with absorption and emission bands in the range of 600-900 nanometers (nm); with extinction coefficients of greater than 50,000 and more preferably greater than 100,000; and/or with quantum efficiencies greater than 0.05, and more preferably greater than 0.1. Examples of suitable imaging agents are described in detail below.

The fluorescent substance may comprise an injectable or topical formulation that can be directly applied to the site of interest for imaging. Injections may be made into the circulatory system, lymphatic system or directly into the tissue or organ of interest. The injection may be carried out prior to, at the beginning of, or during the procedure.

The systems described herein have many surgical applications. The surgical field may be any area of a subject or patient that is being treated. For example, the systems may be used for surgical imaging of the binary tree, lymphatics, the ureter, and blood vessels. The surgical field may also include, for example, a region of the body that includes a tumor that is to be surgically removed. The system may also be utilized as an aid to cardiac surgery, where it may be used during surgery for direct visualization of cardiac blood flow, for direct visualization of myocardium at risk for infarction, and for image-guided placement of gene therapy.

After the fluorescent substance has been administered to the patient, the imaging system (e.g., 110, 210, 310, 410, or 510) is used to acquire reflectance image data and fluorescence image data, according to an exemplary embodiment of the invention. The method typically involves transmitting white light to a surgical site in the subject, transmitting excitation light to the fluorescent substance in the subject, and then periodically acquiring frames of image data, including reflectance data sets and fluorescence emission data sets. The reflectance data comprises reflected visible light from the surgical site (originating from the white light source). The fluorescence data comprises fluorescence emission data that results from exciting the fluorescent substance with the excitation light source. The imaging system may be configured, for example, to acquire a reflectance data set and a fluorescence data set at frame rates between 1 and 60 frames per second, and typically between 15 and 30 frames per second. Alternatively the fluorescence data set and reflectance data set can be acquired at independently controlled frame rates.

The reflectance data sets and the fluorescence data sets may be used to generate a merged image in which the fluorescence image data are overlaid onto the reflectance image data. The merged image assists the surgeon in visualizing certain tissues. The systems may be used for generating superimposed circulatory and tissue images in video format. For example, if the fluorescent substance is injected into a particular vessel of interest, the merged image will highlight the vessel due to the fluorescent emission of the fluorescent substance in the vessel. If desired, the color attributed to fluorescence emission can be modified in generating the merged image so that it is clearly visible to the surgeon. For example, the image processing engine 80 can be configured to transform the color of representation of the fluorescence emission to green prior to generating the merged image. In this way, the fluorescence emission will be clearly visible in the merged image. Visible light tissue images may be displayed with diagnostic image information obtained from outside the visible light range and superimposed onto the visible light image.

According to exemplary embodiments of the invention, the white light source (e.g., 127, 227, 327, 427, 527) is configured to generate light in a first wavelength range, the excitation source (e.g., 123, 223, 323, 423, 523) is configured to generate light at one or more wavelengths for exciting a fluorescent substance, and at least one of the one or more wavelengths generated by the excitation source is within the first wavelength range of the white light source. This configuration can provide the advantage of improved excitation of the fluorescent substance. For example, the fluorescent substance may have improved excitation because it is excited by both the excitation light source and by a portion of the spectrum generated by the white light source.

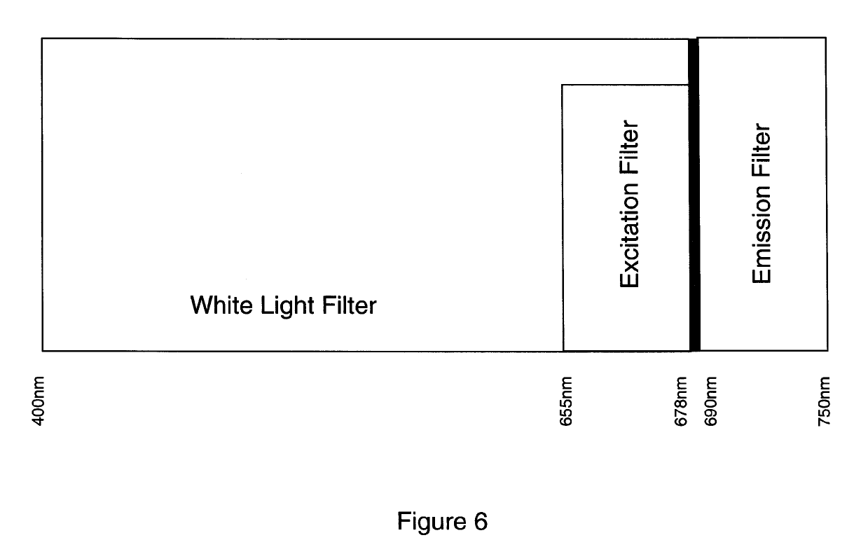

FIG. 6 is an illustration of one example of the wavelength ranges for the white light source, excitation source and fluorescence emission. As shown in FIG. 6, the white light source provides light having a wavelength range of 400-678 nm. The excitation source provides excitation light having a wavelength range of 655-678 nm. The fluorescence emission occupies a wavelength range of about 690-750 nm. As can be seen from FIG. 6, the excitation wavelength spectral range overlaps the white light spectral range. Consequently, the white light source provides additional excitation light for the fluorescent substance. FIG. 6 also shows that there is a spectral gap between the highest excitation wavelength (678 nm) and the lowest fluorescence emission wavelength (690 nm). Accordingly, neither the excitation source nor the white light source interferes with detection of the fluorescence emission.

The wavelength ranges shown in FIG. 6 can be achieved by the use of filters, as will be appreciated by those skilled in the art. For example, the white light range and the excitation range can both be achieved with the use of band pass or short pass filters, or with no filters. The fluorescence emission range can be achieved with low pass, band pass, or notch filters, for example.

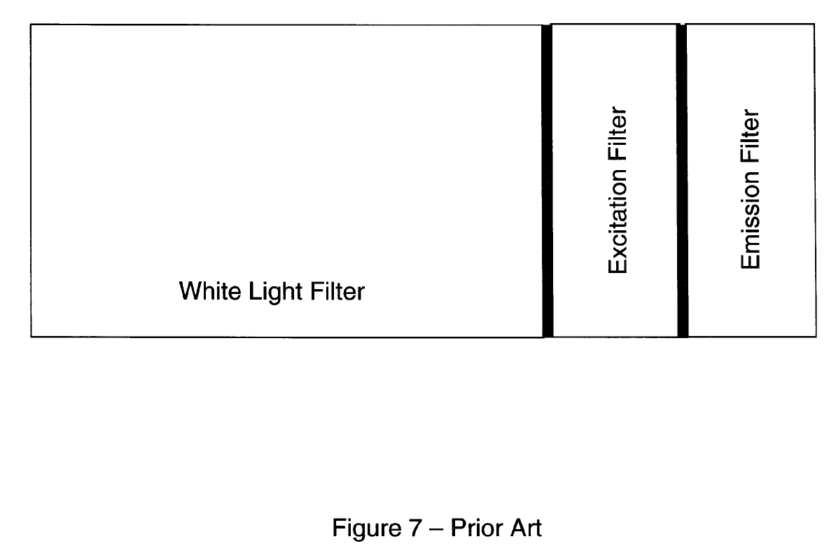

FIG. 7 shows a prior art arrangement in which there is no overlap in the wavelength range between the white light source and the excitation source. The white light source in this arrangement does not provide any contribution to exciting the fluorescent substance.

According to other embodiments of the invention, the white light source generates light in a wavelength range of 400-700 nm. The excitation source is designed to generate light at one or more wavelengths to excite the desired fluorescent substance. Generally, the excitation source is configured to generate light in the absorption spectrum of the desired fluorescent substance. Typically, the excitation wavelength is within the range of 300-850 nm, and more typically in the range of 600-850 nm. According to one embodiment, the excitation range is 650-670 nm. The excitation wavelength is typically within the wavelength range of the white light source. The fluorescent substance absorbs the excitation light and some portion of the white light and in response generates a fluorescent emission at a different, typically higher, wavelength, e.g., 400-900 nm, more typically 650-900 nm. According to one embodiment, the fluorescent emissions range is 690-720 nm.

The wavelength of the fluorescent emission typically does not overlap the wavelength range of the white light source or the excitation source. The wavelength of the fluorescent emission is typically isolated from the wavelength range of the white light source and the excitation source so that the fluorescence emission is more easily detected by the fluorescence camera. Referring to FIG. 1, the filter 129 is typically designed to block any light from the excitation light source 123 and from the white light source 127. The white light source 127 can be designed, with our without the use of filters, so that it does not generate light at the same wavelength as the emission wavelength of the fluorescent substance. The red and near-infrared band is generally understood to include wavelengths between 600 nm and 1000 nm, and is a useful wavelength range for a number of excitation light sources and dyes that may be used with the systems described herein.

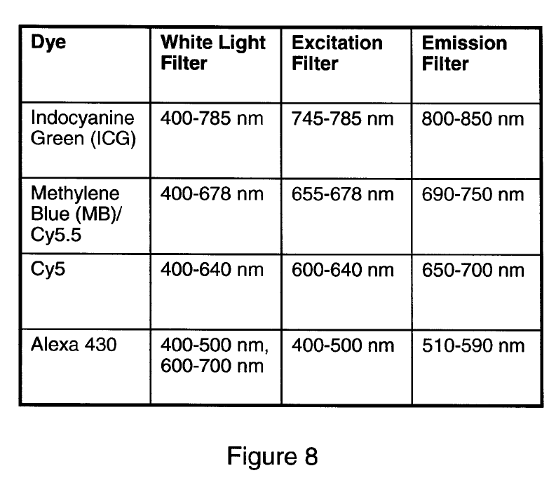

FIG. 8 is a table that provides additional examples of wavelength ranges for dyes, including indocyanine green (ICG), methylene blue (MB), Cy5.5, Cy5, and ALEXA 430 that can be used with exemplary embodiments of the invention.

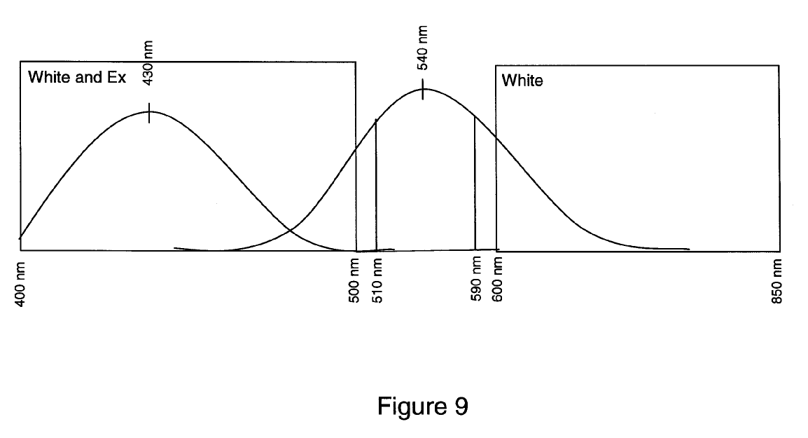

FIG. 9 is a graph that depicts the approximate absorption and emission bands of ALEXA 430. As shown in FIG. 9, ALEXA 430 has a peak absorption at about 430 nm and a peak emission at about 540 nm, representing a relatively large Stokes shift. An example of the white light wavelength band is also shown in FIG. 9. In particular, the white light band may be from 400-500 nm and from 600-850 nm. This spectrum may be achieved, for example, with a notch filter that filters out light having a wavelength of 500-600 nm, as shown in FIG. 9. The notch in the white light spectrum generally coincides with the emission band of the Alexa 430, which is 510-590 nm, as shown in FIG. 9. FIG. 9 also shows that the peak excitation at 430 nm overlaps the white light spectrum, which can provide the advantage that both the excitation source and the white light source contribute to exciting the fluorescent substance.

In some embodiments, the imaging systems use multiple fluorescent detection bands for ratiometric imaging. This feature can be useful, for example, when the target to be visualized is an active enzyme or if it changes in the local environment. The imaging systems may include multiple near infrared (NIR) excitation sources to excite multiple dyes or multiple forms of the same dyes that have different optical properties. In ratiometric imaging, the ratio of emission intensities is measured either (a) in two different regions of the spectrum with a single set of excitation wavelengths (emission ratiometry) or (b) in the same region of the spectrum when the excitation is performed at two different sets of wavelengths (excitation ratiometry). A combination of these two measurements may also be performed. Ratiometric imaging can be beneficial for measuring changes in environment, e.g., ion concentration, pH, oxygen concentration, voltage, etc. from one region to another when using environmentally sensitive dyes, e.g., dyes that undergo spectroscopic changes when placed in different environments. Ratiometric analysis may also be performed with two dyes where both dyes are attached to the same construct and one dye is environmentally sensitive while the other is not.

The imaging systems can also be configured to use multiple fluorescent detection bands for multiple imaging. For example, it may be useful for a surgeon to inject two dyes, such as indocyanine green and methylene blue, into a patient and to excite the two dyes simultaneously with two distinct excitation sources.

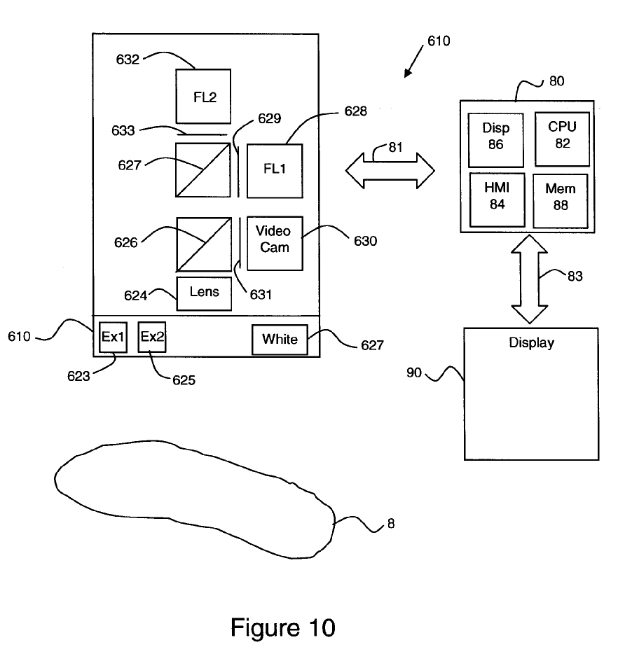

FIG. 10 is a diagram of an imaging system 610 that includes two excitation sources 623, 625, two beam splitters 626, 627, and two fluorescence cameras 628, 632. The imaging system 610 works much like the imaging system 110 in FIG. 1, except that the fluorescence camera 128 in FIG. 1 has been replaced by a beam splitter 627 and two fluorescence cameras 628, 632 in FIG. 10; and the excitation source 123 in FIG. 1 has been replaced by two excitation sources 623 and 625 in FIG. 10. The beam splitter 627 splits the fluorescence emission from the subject 8 into two different wavelength bands. One of the wavelength bands is detected by the first fluorescence camera 628. The second wavelength band is detected by the second fluorescence camera 632. Each camera has a filter 629, 633 configured to reject the reflected visible and excitation light from being detected by the respective fluorescence camera 628, 632 while allowing the emitted fluorescent light from the subject 8 to be detected by the respective fluorescence camera 628, 632.

The imaging system 610 can be used, for example, to excite a dye at two separate excitation wavelengths or to excite two different dyes at different excitation wavelengths. The imaging system 610 can also be used to detect fluorescence emissions at two different wavelengths with the two fluorescence cameras. The imaging system 610 is useful for ratiometric or multiple imaging. Those skilled in the art will appreciate that the endoscope systems shown in FIGS. 2-5 can also be configured to include multiple excitation sources and/or multiple fluorescence detectors.

Exemplary embodiments of the imaging system may comprise a multi-color imaging instrument and red and near IR imaging agents. The imaging system provides simultaneous display of color images as well as one or more fluorescent images. The imaging instrument may include an improved light source with an array of lighting modules, where each module may comprise a plurality of individual light sources. Modules in each array may all provide light at one wavelength or separate sets of modules may provide light at different wavelengths.

The imaging system may be surrounded by an operating area closed to ambient light. Many visible light sources such as incandescent lamps, halogen lamps, or daylight may include a broad spectrum of electromagnetic radiation that extends beyond the range of visible light detected by the human eye and into wavelengths used in the present system as a separate optical channel for generating diagnostic images. In order to effectively detect emissions in these super-visible light wavelengths, it is preferred to enclose the surgical field, light sources, and cameras in an area that is not exposed to broadband light sources. This may be achieved by using an operating room closed to external light sources or by using another enclosure for the surgical field that prevents invasion by unwanted light sources. The visible light source may then serve as a light source for the visible light camera, and also for providing conventional lighting within the visible light spectrum.

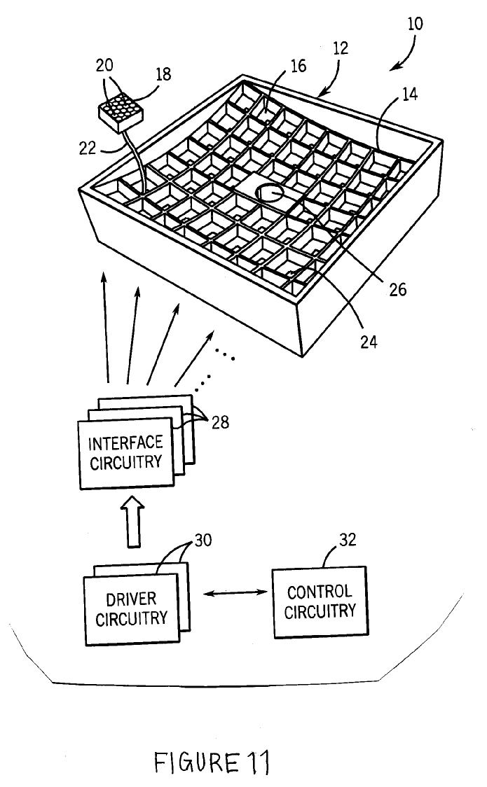

Exemplary embodiments of the invention also provide improved light sources, including at least one excitation source and a white light source. FIGS. 11-14 depict a light source 10 according to an exemplary embodiment of the invention. In FIG. 11, the light source 10 is illustrated generally, along with the associated circuitry for controlling its operation. The light source 10 is made up of a housing 12 in which a frame 14 is disposed. The frame 14 fits within the housing and is formed to focus light radiation from the light source as described more fully below. In the illustrated embodiment, the frame 14 defines an array of receptacles 16, each of which is designed to accommodate a lighting module, one of which is illustrated in FIG. 10 and designated by the reference numeral 18. As described more fully below, each module may be made up of a plurality of lights, particularly of commercially available LEDs arranged in a tight pattern, as designated in FIG. 10 by reference numeral 20. Each module is supplied with power for illuminating the LEDs by means of a cable 22. Passages 24 are provided in the base of each receptacle for allowing the cable to exit the receptacle and join power and control circuitry as described below.

In some embodiments, the light source 10 described herein provides a diffuse illuminator that utilizes commercially available LED packages of any suitable wavelength or form factor. The design incorporates a modularized surface that can focus the sources at desired focal points. As described below, the light source 10 may also incorporate fixtures needed for filtering light as well as various techniques for fixturing the LEDs and other components. The LEDs themselves, depending upon the application, may be of various colors and wavelengths, with multiple LEDs being provided, where desired. The light source 10 can thus provide a high power illuminator with high concentration of power in a set region of interest, tunable to any wavelength or combination of wavelengths, according to various embodiments of the invention. The light can be switched at low frequencies or intensity modulated at very high frequencies.

In the embodiment shown in FIG. 10, the array of lighting modules includes seven modules in the first direction and eight modules in a second direction. The number, size and placement of these modules in the array, however, can be changed to allow for selection of a variety of discreet units, assembly of modular, scalable and configurable light sources, and for focusing the emitted radiation in relatively confined or more diffuse areas. For example, if a certain wavelength of light is needed at high power, the source can be populated with one type of module. If two wavelengths are required, two types of modules may be selected, and so forth. The intensity of the modules may be selected to achieve high power as would otherwise be provided at only one wavelength. Other illumination modules, such as laser diodes, may also be used where desired.

To support the modules in operation, various electrical circuitry is contemplated. In the diagram of FIG. 11, for example, interface circuitry 28 allows for connections between the various modules and driver circuitry 30. In presently contemplated embodiments, an interface circuit board of the circuitry 28 is provided for each individual module, with LEDs of that module connected in series. In the same presently contemplated embodiment, driver circuitry 30 comprises two driver boards that supply power to the interface circuitry, which then routes the power to the modules. Both the interface circuitry and the driver circuitry may permit for individually addressing modules, such as to selectively illuminate only certain modules. This may be particularly desirable where specific areas are to be illuminated, intensities are to be chosen, or specific wavelengths to be chosen for individual applications or during certain periods of use. Control circuitry 32 is coupled to the driver circuitry to allow for such control, to switch on power to one or more modules, and so forth. The circuitry is, of course, not limited to that represented in this or other figures, and particular circuits may be adapted to permit any desired control, addressing of modules, modulation of output intensity, and so forth.

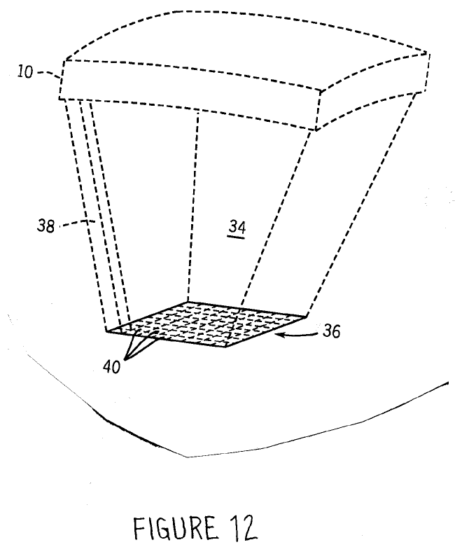

The radiation emitted by the various modules may be focused by virtue of the geometry of the array defined by the housing and frame shown in FIG. 11, as generally illustrated in FIG. 12. As shown in FIG. 12, the light source 10, by virtue of its geometry, will focus radiation, designated generally by reference numeral 34, towards an illuminated region 36. In particular, each of the modules illustrated in FIG. 11 will direct a beam of radiation, one of which is illustrated in FIG. 12 and indicated by reference numeral 38, towards individual areas 40 within the illuminated region 36. The regions may overlap, or may be separate from one another, depending upon the geometry of the array and the desired distance that the illuminated region 36 lies from the array.

In one particular embodiment, the light source has dimensions of approximately 25×30 cm and provides converging radiation so as to focus radiation on an area of approximately 12×12 cm² at a distance of approximately 50 cm. The light source can provide an energy density at the illuminated surface of approximately 0.5-200 milliWatts per square centimeter (mW/cm²), more typically 1-100 mW/cm², and most typically 1-50 mW/cm².

FIG. 13 illustrates an exemplary imaging unit 120 that incorporates this arrangement for imaging purposes. The imaging unit 120 includes various imaging components, based around the light source 10 and disposed in a frame or housing. In particular, the frame 68 supports the light source 10 along with an optical system 66 that channels returned radiation through a receiver 70 for generating images. The imaging device will typically be positioned over a subject and adjusted so that the desired energy density of radiation is provided at the tissue of interest, with returned radiation being used for imaging. In such applications, it may be advantageous to provide two or more different wavelengths of light, and this may be accomplished by selecting appropriate LEDs, modules, or filters that output the desired wavelengths. For example, wavelengths in the visible and infrared spectra may be used along with white light. Other wavelengths and spectra may, of course, be employed.

FIG. 14 illustrates an exemplary medical imaging application of this type, in which an imaging system employs an imaging unit 120 of the type illustrated in FIGS. 1 and 13. The system is used for generating images of a subject 8 by the use of concentrated incoherent light from the light source 10. In general, the subject may be seated or reclined on a table 76, such as in a surgical suite in surgical applications. The imaging unit 120 is positioned above the patient by means of a support structure 78. The imaging unit 120 is connected to the image processing engine 80 and the display 90, as described above in connection with FIG. 1.

Again, those skilled in the art will appreciate that the arrangement of FIG. 14 may be employed for clinical imaging, during surgery, and so forth. In a surgical application, for example, real time fluorescent imaging may be performed by illuminating exposed tissues in which fluorescent agents or dyes have been injected. The dyes will typically fluoresce when excited by light at known wavelengths provided by the light source described above, and will then return radiation that can be detected, converted to corresponding electrical signals. e.g., in an imaging detector or camera, and these signals used by the image processing engine 80 to reconstruct images.

Typically, the white light source has an intensity of 100-20,000 lux, more typically 10,000-100,000 lux, and most typically 40,000-60,000 lux. The white light source typically has, either alone or in combination with the excitation source, a correlated color temperature of 2800-10,000 degrees Kelvin, more preferably 3000-6700 degrees Kelvin, and a color rendering index (CRI) of 10-100, more preferably 85-100.

The light source 10 can also be adapted for other particular applications. For example, in some applications it may be advantageous for the light source to be closer to the subject and portable. Accordingly, the light source can be designed to be a hand-held, smaller, less powerful, close range light source. The light source may be adapted, for example, to use fiber optic cables to transmit white light and/or excitation light to the subject.

As described above, the imaging agents used with the imaging system may comprise fluorescent dyes, pigments, nanoparticles, or combinations thereof, either by themselves or as conjugates of carriers that are targeted or non-targeted. Imaging agents also comprise small organic molecules that may be metabolized by the target organ or tissue to endogenously create a fluorescent molecule. Examples of such small molecules includes esters of ALA. Imaging agents may be injectables or topical formulations that can be directly applied to the site of interest for imaging. Injections may be made into the circulatory system, lymphatic system or directly into the tissue/organ of interest.

In some embodiments, the imaging agents absorb light having a wavelength greater 300 nm, e.g., greater than 400 nm, greater than 500 nm, greater than 600 nm, greater than 700 nm, greater than 800 nm, or greater than 900 nm. In terms of ranges, the imaging agents absorb light having a wavelength in the range of from about 350 nm to about 1000, e.g., from about 350 nm to about 500 nm, from about 350 nm to about 480 nm, from about 600 nm to about 1000 nm, from about 600 nm to about 900 nm, from about 600 nm to about 700 nm, from about 700 nm to about 900 nm, or from about 700 nm to about 1000 nm, preferably from about 650 to about 800 nm. In some embodiments, when the imaging agents are irradiated with light having the aforementioned wavelengths, the imaging agents emit light having a wavelength greater than 400 nm, e.g., greater than 500 nm, greater than 600 nm, greater than 700 nm, greater than 800 nm, or greater than 900 nm. In terms of ranges, the imaging agents emit light having a wavelength in the range of from about 450 nm to about 1000 nm, e.g., from about 490 nm to about 540 nm, from about 600 nm to about 1000 nm, from about 600 nm to about 900 nm, from about 600 nm to about 700 nm, from about 700 nm to about 900 nm, or from about 700 nm to about 1000 nm, most preferably from about 670 nm to about 850 nm. In some embodiments, the imaging agents of the present invention have extinction coefficients greater than 50,000 M⁻¹cm⁻¹, e.g., greater than 70,000 M⁻¹cm⁻¹, greater than 90,000 M⁻¹cm⁻¹, or greater than 100,000 M⁻¹cm⁻¹. In some embodiments, the imaging agents of the present invention have quantum efficiencies of greater than 0.05, e.g., greater than 0.07, greater than 0.09, most preferably greater than 0.1.

Exemplary imaging agents include the dyes disclosed in Published U.S. Patent Application Nos. 20020115862; 20060179585, and 20050182321, the disclosures of which are incorporated herein by reference as if fully set forth herein.

Published U.S. Patent Application No. 20020115862 discloses dyes of the general formula I, and their pharmaceutically acceptable salts:

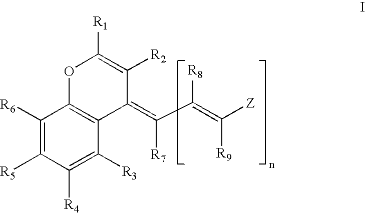

where Z is a substituted derivative of benzooxazol, benzothiazol, 2,3,3-trimethylindolenine, 2,3,3-trimethyl-4,5-benzo-3H-indolenine, 3- and 4-picoline, lepidine, chinaldine and 9-methylacridine derivatives with the general formulae Ia, Ib, or Ic:

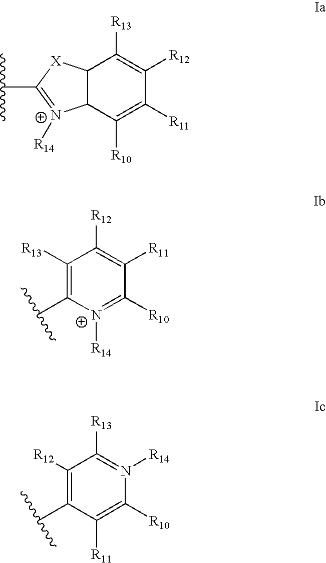

where X is an element selected from the group consisting of O, S, Se or the structural element N-alkyl or C(alkyl)₂; n is 1, 2 or 3; R₁-R₁₄ are the same or different and can be hydrogen, one or more alkyl, aryl, heteroaryl or heterocycloalipathic fragments, a hydroxy or alkoxy group, an alkyl substituted, or cyclical amine function and/or two fragments in ortho position to each other, for example R₁₀ and R₁₁, can together form another aromatic ring; at least one of the substituents R₁-R₁₄ can be a solubilizing or ionizable or ionized substituent, such as a polyethyleneglycol, cyclodextrin, sugar, SO₃⁻, PO₃²⁻, COO⁻, or NR₃⁺, which determines the hydrophilic properties of these dyes. In some embodiments, the solubilizing or ionizable or ionized substituent is bound to the dye by means of a spacer group. In some embodiments, at least one of the substituents R₁-R₁₄ can be a reactive group which facilitates a covalent linking of the dye to a carrier molecule, while this substituent can also be bound to the dye by means of a spacer group. In other embodiments, R₁ is a substituent which has a quaternary C-atom in alpha-position relative to the pyran ring, e.g., t-butyl and adamantyl. As used herein, the term “carrier molecule” is defined as a targeting moiety specifically targeted to a particular target (e.g, antigens, cell surface receptors, intracellular receptors, proteins, nucleotides, cellular organelles, extracellular structures, e.g., an extracellular matrix or collagen) in the tissue or organ of interest or a non-specific chemical entity that is either used simply to enhance circulation time or causes transient accumulation of dye in the area of interest. Exemplary non-specific chemical entities include, without limitation, a variety of macromolecules such as, polylysines, polyethylene glycols, dendrimers, cyclodextrans, poly peptides, poly-lactic acid, and the like.

The present invention further contemplates the use of compounds of the formula I where R₁-R₁₄ are the same or different and can be a fluoro or chloro, in addition to the other aforementioned substituents.

Published U.S. Patent Application No. 20060179585 discloses dyes of the formulae II-VII, and their pharmaceutically acceptable salts:

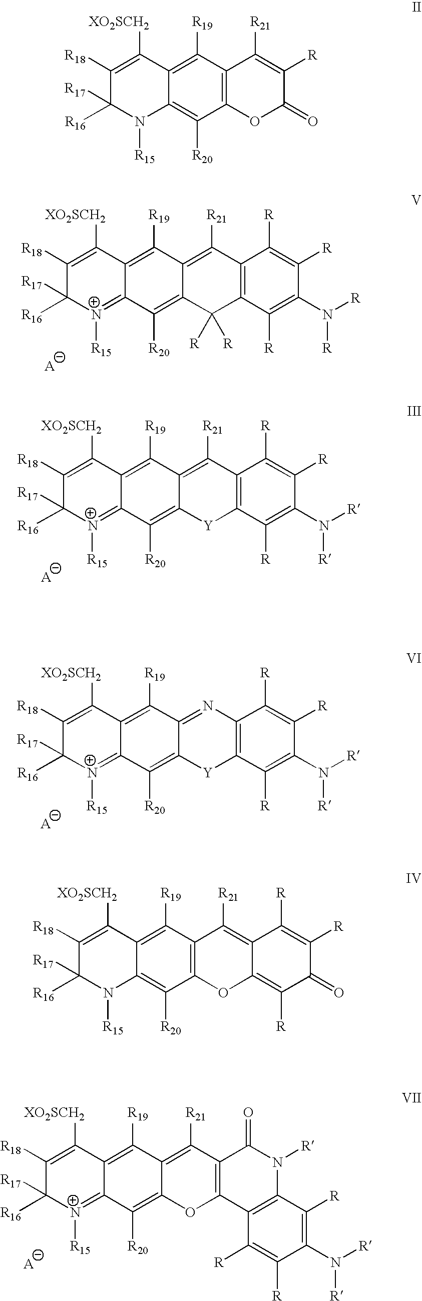

wherein R₁₅ denotes hydrogen or a hydrocarbon group with 1-20 carbon atoms where the hydrocarbon group can optionally contain one or more heteroatoms and/or one or more substituents; R₁₆, R₁₇, R₁₈, R₁₉, and R₂₀ on each occurrence and independently of one another denote hydrogen, halogen, a hydroxy, amino, sulfo, carboxy or aldehyde group or a hydrocarbon group with 1-20 carbon atoms where the hydrocarbon group can optionally contain one or more heteroatoms and/or one or more substituents, or the residues R₁₅ and R₂₀ together form a ring system; R on each occurrence can be the same or different and is defined as for R₁₅, R₁₆, R₁₇, R₁₈, R₁₉ and R₂₀; R′ on each occurrence and independently of one another denotes hydrogen or a hydrocarbon group with 1-20 carbon atoms where the hydrocarbon group can optionally contain one or more heteroatoms and/or one or more substituents, or the residues R and R′ together form a ring system which can contain one or more double bonds; R₂₁ on each occurrence and independently of one another denotes hydrogen or a hydrocarbon group with 1-20 carbon atoms where the hydrocarbon group can optionally contain one or more heteroatoms and/or one or more substituents, where R₂₁ in particular represents hydrogen, aryl, carboxyphenyl, alkyl, perfluoroalkyl, cycloalkyl, pyridyl or carboxypyridyl; X denotes OH, halogen, —O—R₂₂, —S—R₂₃ or —NR₂₄R₂₅ where R₂₂, R₂₃, R₂₄, and R₂₅ each independently of one another denote hydrogen or a C1 to C20 hydrocarbon residue which can optionally contain one or more heteroatoms or one or more substituents; and Y in formula III denotes O, S or Se; and Y in formula VI denotes O, S or C(R)₂.

Published U.S. Patent Application 20050182321 discloses dyes of the general formula VIII, and their pharmaceutically acceptable salts:

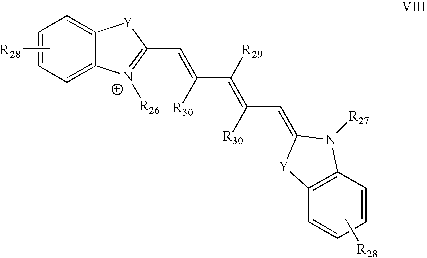

wherein, as valence and stability permit, Y represents C(R₃₀)₂, S, Se, O, or NR₃₁; R₃₀ represents H or lower alkyl, or two occurrences of R₃₀, taken together, form a ring together with the carbon atoms through which they are connected; R₂₆ and R₂₇ represent, independently, substituted or unsubstituted lower alkyl, lower alkenyl, cycloalkyl, cycloalkylalkyl, aryl, or aralkyl, e.g., optionally substituted by sulfate, phosphate, sulfonate, phosphonate, halogen, hydroxyl, amino, cyano, nitro, carboxylic acid, amide, etc., or a pharmaceutically acceptable salt thereof; R₂₈ represents, independently for each occurrence, one or more substituents to the ring to which it is attached, such as a fused ring (e.g., a benzo ring), sulfate, phosphate, sulfonate, phosphonate, halogen, lower alkyl, hydroxyl, amino, cyano, nitro, carboxylic acid, amide, etc., or a pharmaceutically acceptable salt thereof, R₂₉ represents H, halogen, or a substituted or unsubstituted ether or thioether of phenol or thiophenol; and R₂₈ represents, independently for each occurrence, substituted or unsubstituted lower alkyl, cycloalkyl, cycloalkylalkyl, aryl, or aralkyl, e.g., optionally substituted by sulfate, phosphate, sulfonate, phosphonate, halogen, hydroxyl, amino, cyano, nitro, carboxylic acid, amide, etc., or a pharmaceutically acceptable salt thereof Dyes representative of this formula include indocyanine green, as well as:

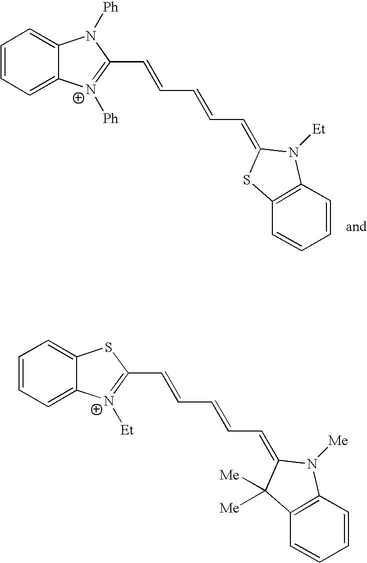

In certain embodiments wherein two occurrences of R₃₀ taken together form a ring, the ring is five or six-membered, e.g., the fluorescent dye has a structure of formula:

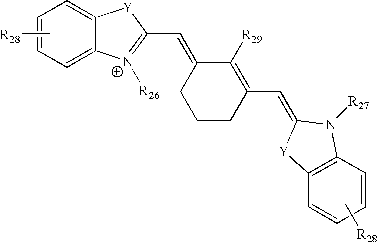

wherein Y, R₂₆, R₂₇, R₂₈, R₂₉, and R₃₀ represent substituents as described above. Dyes representative of this formula include IRDye78, IRDye80, IRDye38, IRDye40, IRDye41, IRDye700, IRDye800 (Li-Cor Biosciences, Lincoln, Nebr.), and compounds formed by conjugating a second molecule to any such dye, e.g, a protein or nucleic acid conjugated to IRDye800, IRDye40, or Cy7, etc. The IRDyes are commercially available, and each dye has a specified peak absorption wavelength (also referred to herein as the excitation wavelength as generally the absorption and excitation spectra of dyes are similar) and peak emission wavelength that may be used to select suitable optical hardware for use therewith. IRDye78-CA is useful for imaging the vasculature of the tissues and organs. The dye in its small molecule form is soluble in blood, and has an in vivo early half-life of several minutes. This permits multiple injections during a single procedure. Indocyanine green has similar characteristics, but is somewhat less soluble in blood and has a shorter half-life. IRDye78 may also be used in other imaging applications, since it can be conjugated to tumor-specific ligands for tumor visualization. More generally, IRDye78 may be linked to an antibody, antibody fragment, or ligand associated with a tumor. The presence of the tumor or lesion may then be visualized. As another example, IR-786 partitions efficiently into mitochondria and/or the endoplasmic reticulum in a concentration-dependent manner, thus permitting blood flow and ischemia visualization in a living heart. The dye has been successfully applied, for example, to image blood flow in the heart of a living laboratory rat after a thoracotomy. More generally, IR-786 may be used for non-radioactive imaging of areas of ischemia in the living heart, or other visualization of the viability of other tissues.

Other exemplary imaging agents include dyes of the formula IX, and their pharmaceutically acceptable salts:

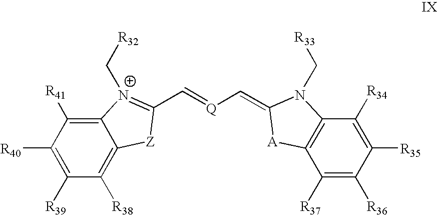

wherein Q is selected from the group consisting of:

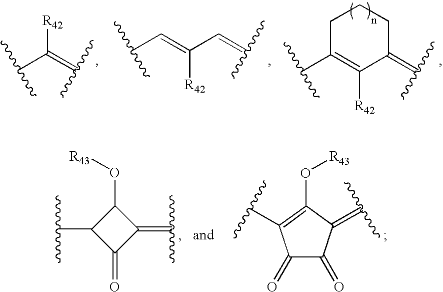

wherein Z and A are selected from the group consisting of NR₄₄, O, S, and CR₄₅R₄₆, where R₄₂ is selected from the group consisting of hydrogen, halogen, hydroxyl, alkoxy, alkyl, substituted alkyl, aryloxy, and substituted aryloxy; R₄₃ is selected from the group consisting of hydrogen, alkoxy, and aryloxy; R₃₂-R₄₂ and R₄₄-R₄₆ are independently selected from the group consisting of hydrogen, halogen, hydroxyalkyl, alkylaryl, and substituted or unsubstituted arylalkyl; and n is 0, 1, or 2. By “substituted” it is meant that the group bearing the substitution can be substituted with groups including, but not limited to, halogen, hydroxyl, amine, alkoxy, sulfonate, phosphonate, carboxylic acid, ester, amide, keto group, reactive groups for conjugations to vectors (i.e., a targeting molecule, including peptides, aptamers, antibodies, antibody fragments, or any suitable biomolecule and may also include organic polymers, dendrimers, or nanoparticles) or hydrophilic groups (e.g., polyethers and polyhydroxy compounds such as carbohydrate moieties) and vectors or hydrophilic groups themselves. In embodiments where the vector is a targeting molecule (e.g., an antibody) or a non-targeted molecule (e.g., a macromolecule such a polylysine, dextran, polyethylene glycol, etc.), two or more of any of the above-mentioned dyes may be attached to a single targeting or non-targeting molecule.

Still other exemplary imaging agents include dyes falling under the following general classes of compounds (and their pharmaceutically acceptable salts):

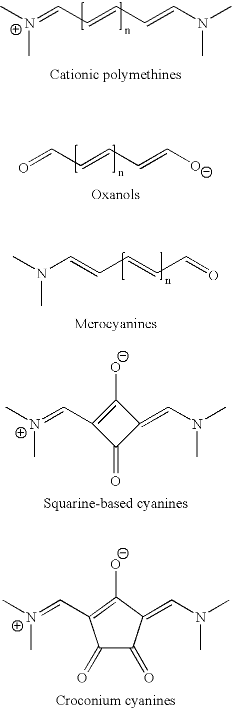

Examples of such compounds are disclosed in Mishra et al., Chem. Rev. 100:1973-2011 (2000); and Frances M Hamer, Cyanine Dyes and Related Compounds (Interscience 1964).

Other exemplary imaging agents include phenothiazines such as methylene blue and cyanines such as Cy5 and Cy5.5 (GE Healthcare). Still other exemplary imaging agents include Dy630-Dy636, Dy647-Dy649, Dy650-652, Dy675-Dy677, Dy680-682, Dy700, Dy701, Dy730-Dy732, Dy734, Dy750-Dy752, Dy776, Dy780-Dy782, Dy831 or mixtures or conjugates thereof, and Atto633, Atto635, Atto637, Atto647, Atto655, Atto680, Atto700, Atto725, Atto740 or mixtures or conjugates thereof.

As used herein, “pharmaceutically acceptable salts” refers to derivatives of the disclosed compounds wherein the parent compound is modified by making the acid or base salts thereof. Examples of pharmaceutically acceptable salts include, but are not limited to, mineral or organic acid salts of basic residues such as amines; alkali or organic salts of acidic residues such as carboxylic acids; and the like. The pharmaceutically acceptable salts include the conventional non-toxic salts or the quaternary ammonium salts of the parent compound formed, for example, from non-toxic inorganic or organic acids. For example, such conventional non-toxic salts include those derived from acids such as hydrochloric, hydrobromic, sulfuric, sulfamic, phosphoric, nitric and the like; and the salts prepared from organic acids such as acetic, propionic, succinic, glycolic, stearic, lactic, malic, tartaric, citric, ascorbic, pamoic, maleic, hydroxymaleic, phenylacetic, glutamic, benzoic, salicylic, sulfanilic, 2-acetoxybenzoic, fumaric, toluenesulfonic, methanesulfonic, ethane disulfonic, oxalic, isethionic, and the like. Conventional non-toxic salts also include those derived from inorganic bases such ammonia, L-arginine, benethamine, benzathine, calcium hydroxide, choline, deanol, diethanolamine, diethylamine, 2-(diethylamino)-ethanol, ethanolamine, ethylenediamine, N-methyl-glucamine, hydrabamine, 1H-imidazole, L-lysine, magnesium hydroxide, 4-(2-hydroxyethyl)-morpholine, piperazine, potassium hydroxide, 1-(2-hydroxyethyl)-pyrrolidine, secondary amine, sodium hydroxide, triethanolamine, tromethamine and zinc hydroxide.

While a number of suitable imaging agents have been described, it should be appreciated that such imaging agents are examples only, and that more generally, any fluorescent substance may be used with the imaging systems described herein, provided the substance has an emission wavelength that does not interfere with visible light imaging. This includes the dyes described above, as well as substances such as quantum dotswhich may have emission wavelengths from 500-1300 nm, carbon nanotubes, fluorescent silicon nanoparticles and may be associated with an antibody, antibody fragment, or ligand and imaged in vivo. All such substances are referred to herein as imaging agents, and it will be understood that suitable modifications may be made to components of the imaging system for use with any such imaging agents.

While the foregoing description includes details and specific examples, it is to be understood that these have been included for purposes of explanation only, and are not to be interpreted as limitations of the present invention. Modifications to the embodiments described herein can be made without departing from the spirit and scope of the invention, which is intended to be encompassed by the following claims and their legal equivalents.

1. An imaging system comprising:
a white light source configured to generate light in a first wavelength range;
an excitation source configured to generate light at one or more wavelengths for exciting a fluorescent substance;
a first detector configured to acquire reflectance image data that represents light reflected from a subject; and
a second detector configured to acquire fluorescence image data that represents fluorescence emissions from the subject;
wherein at least one of the one or more wavelengths generated by the excitation source is within the first wavelength range of the white light source.

2. The system of claim 1, further comprising a processor configured to generate an image based on the reflectance image data and the fluorescence image data.

3. The system of claim 2, wherein the fluorescence image data is superimposed on the reflectance image data in the image.

4. The system of claim 2, further comprising a display for displaying the image.

5. The system of claim 2, wherein the processor is configured to modify a color of the fluorescence image data.

6. The system of claim 2, wherein the processor is configured to modify a color of the reflectance image data.

7. The system of claim 1, wherein the first wavelength range of the white light source is about 400-785 nanometers and the one or more wavelengths of the excitation source is about 745-785 nanometers.

8. The system of claim 1, wherein the first wavelength range of the white light source is about 400-678 nanometers and the one or more wavelengths of the excitation source is about 655-678 nanometers.

9. The system of claim 1, wherein the first wavelength range of the white light source is about 400-640 nanometers and the one or more wavelengths of the excitation source is about 600-640 nanometers.

10. The system of claim 1, wherein the first wavelength range of the white light source is about 400-500 and 600-700 nanometers and the one or more wavelengths of the excitation source is about 400-500 nanometers.

11. The system of claim 1, further comprising a third detector configured to acquire fluorescence image data that represents fluorescence emissions from the subject.

12. The system of claim 1, further comprising a second excitation source.

13. The system of claim 12, wherein the first and second excitation sources are configured to excite a single fluorescent substance at two distinct wavelengths.

14. The system of claim 1, further comprising an endoscope, and wherein the first and second detectors are located in a distal end of the endoscope.

15. The system of claim 1, further comprising an endoscope, and wherein the white light source and the excitation source are coupled to the endoscope at a proximal end of the endoscope.

16. The system of claim 1, wherein said fluorescent substance comprises indocyanine green. 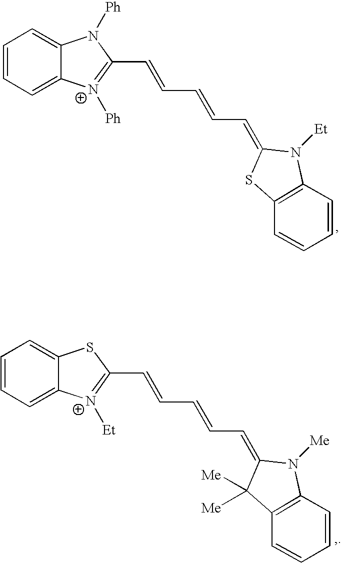
mixtures thereof or conjugates thereof.

17. The system of claim 1, wherein said fluorescent substance comprises IRDye78, IRDye80, IRDye38, IRDye40, IRDye41, IRDye700, IRDye800, IRDye78-CA, IR-786, mixtures thereof, or conjugates thereof.

18. The system of claim 1, wherein said fluorescent substance comprises methylene blue, Cy5, Cy5.5, and Cy 7, mixtures thereof, or conjugates thereof.

19. The system of claim 1, wherein said fluorescent substance comprises Dy630-Dy636, Dy647-Dy649, Dy650-Dy652, Dy675-Dy677, Dy680-Dy682, Dy700, Dy701, Dy730-Dy732, Dy734, Dy750-Dy752, Dy776, Dy780-Dy782, Dy831 or mixtures or conjugates thereof.

20. The system of claim 1, wherein said fluorescent substance comprises Atto633, Atto635, Atto637, Atto647, Atto655, Atto680, Atto700, Atto725, Atto740 or mixtures or conjugates thereof.

21. A method comprising:
illuminating a subject with a white light source configured to generate light in a first wavelength range;
illuminating the subject with an excitation source configured to generate light at one or more wavelengths for exciting a fluorescent substance;
acquiring reflectance image data that represents light reflected from the subject; and
acquiring fluorescence image data that represents fluorescence emissions from the subject;
wherein at least one of the one or more wavelengths generated by the excitation source is within the first wavelength range of the white light source.

22. The method of claim 21, further comprising generating an image based on the reflectance image data and the fluorescence image data.

23. The method of claim 22, further comprising displaying the image.

24. The method of claim 22, further comprising modifying a color of the fluorescence image data.

25. The method of claim 21, wherein the subject comprises a ureter, lymphatics, or binary tree.

26. The method of claim 21, wherein the subject comprises a tumor.

27. The method of claim 21, wherein the subject comprises a blood vessel.

28. The method of claim 21, wherein the subject comprises a nerve.

29. The method of claim 21, wherein the first wavelength range of the white light source is about 400-785 nanometers and the one or more wavelengths of the excitation source is abut 745-785 nanometers.

30. The method of claim 21, wherein the first wavelength range of the white light source is about 400-678 nanometers and the one or more wavelengths of the excitation source is abut 655-678 nanometers.

31. The method of claim 21, wherein the first wavelength range of the white light source is about 400-640 nanometers and the one or more wavelengths of the excitation source is abut 600-640 nanometers.

32. The method of claim 21, wherein the first wavelength range of the white light source is about 400-500 and 600-700 nanometers and the one or more wavelengths of the excitation source is abut 400-500 nanometers.

33. The method of claim 21, further comprising:
illuminating the subject with a second excitation source; and
calculating a ratio of intensities of fluorescence emissions.

34. The method of claim 21, wherein the acquiring of fluorescence image data is conducted at two different regions of the spectrum, and further comprising calculating a ratio of emission intensities at the two different regions of the spectrum.

35. The method of claim 21, further comprising administering the fluorescent substance to the subject.

36. The method of claim 35, wherein said fluorescent substance comprises indocyanine green, 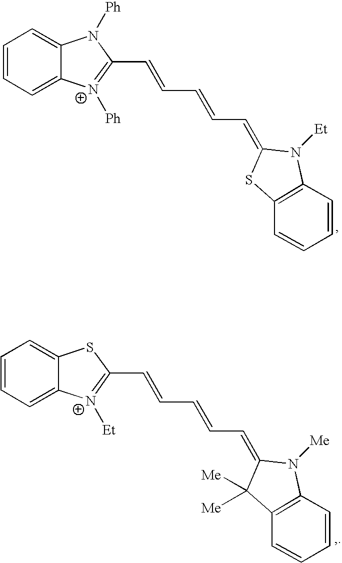
mixtures thereof or conjugates thereof.

37. The method of claim 35, wherein said fluorescent substance comprises IRDye78, IRDye80, IRDye38, IRDye40, IRDye41, IRDye700, IRDye800, IRDye78-CA, IR-786, mixtures thereof, or conjugates thereof.

38. The method of claim 35, wherein said fluorescent substance comprises methylene blue, Cy5, Cy5.5, Cy7, mixtures thereof, or conjugates thereof.

39. The method of claim 35, wherein said fluorescent substance comprises Dy630-Dy636, Dy647-Dy649, Dy650-Dy652, Dy675-Dy677, Dy680-Dy682, Dy700, Dy701, Dy730-Dy732, Dy734, Dy750-Dy752, Dy776, Dy780-Dy782, Dy831 or mixtures or conjugates thereof.

40. The method of claim 35, wherein said fluorescent substance comprises Atto633, Atto635, Atto637, Atto647, Atto655, Atto680, Atto700, Atto725, Atto740 or mixtures or conjugates thereof.
